(19) United States
(12) Patent Application Publication
(10) Pub. No.: US 2002/0121617 A1
(43) Pub. Date: Sep. 5, 2002

(54) Power supply unit for a hydraulic system

(76) Inventor: Chung Li Hu, Taichung (TW)

Correspondence Address: Kuo-Hsiung Chiu, 13F, No.23, Jiun-Ho Street, Peitun District, Taichung, 406, TW

(21) Appl. No.: 09/796,982

(22) Filed: Mar. 2, 2001

(51) Int. Cl. F16K 31/02

(52) U.S. Cl. 251/129.04; 251/129.15

(57) ABSTRACT

The present invention relates to a power supply unit for a hydraulic system, wherein a sensor is fitted to a spout of a channel of an automatic water supply unit. This sensor is connected to a chip set controlling the opening or closing state of an electromagnetic valve. When objects approach to the spout, the electromagnetic valve is able to be opened for supply water. A power supply unit is disposed at a proper position of the flow channel, and the power supply unit can generate a basic voltage (V) and current (A) by means of the velocity of the flowing fluid in a unit time for creating a basic work (W) for the chip set in opening the electromagnetic valve.

### BACKGROUND OF THE INVENTION

1. Field of the Invention

The present invention relates to a power supply unit for a hydraulic system, and more particularly to a power supply unit for a hydraulic system by means of hydroelectric generation.

2. Description of the Prior Art

An automatic water supply unit is very popular in household or public lavatory. The so-called automatic water supply unit is used to control the outflow of the water at the lavatory by means of an electromagnetic valve which is connected to a sensor at outer side for sensing if objects approach to the spout of fittings and a circuit board inside for receiving the sensed signal by the sensor, thereby opening or closing the electromagnetic valve. The electric power required by the circuit board for opening or closing the electromagnetic valve and in stand-by mode is supplied by a battery or mains current. The battery can't be used for a longer period so that it has to be replaced frequently, thereby causing much inconvenience. Besides, the wiring is troublesome when the main current is applied; also, it is easy to be destroyed. The electromagnetic valve doesn't work in case of power failure.

### SUMMARY OF THE INVENTION

It is a primary object of the present invention to eliminate the drawbacks associated with the prior art and to provide a power supply unit for a hydraulic system, wherein the power required to open the electromagnetic valve is supplied by means that the fluid passes through the power supply unit.

### BRIEF DESCRIPTION OF THE DRAWINGS

The accomplishment of this and other objects of the invention will become apparent from the following description and its accompanying drawing of which:

FIG. 1 is a schematic drawing of the present invention.

### DETAILED DESCRIPTION OF THE PREFERRED EMBODIMENT

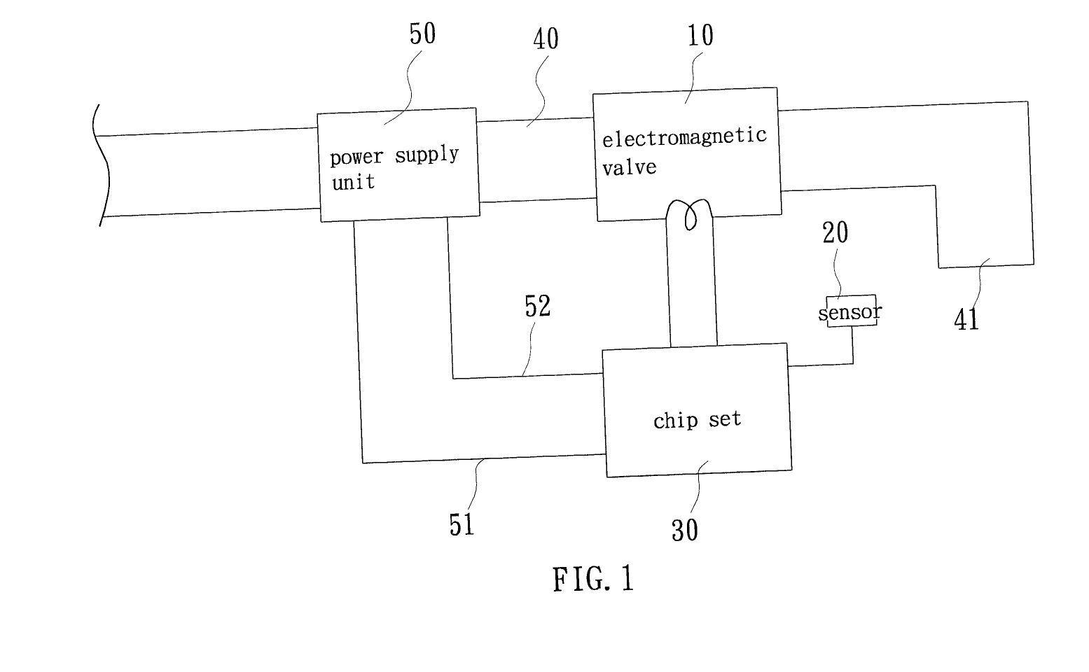

Referring to FIG. 1, the power supply unit for a hydraulic system in accordance with the present invention includes an electromagnetic valve 10, a sensor 20 and a chip set 30. The electromagnetic valve 10 is disposed near a spout 41 of a fluid channel 40 in an open or closed mode for controlling the outflow of the fluid. The sensor 20 is fitted at circumference of the spout 41 for sensing an object approaching to the spout 41 by means of image or temperature detection, thereby giving a signal. Moreover, the chip set 30 is connected to the electromagnetic valve 10, the sensor 20 and a power supply unit 50. The signal sent by the sensor 20 is used as a command to open or close the electromagnetic valve 10. The power supply unit 50 can supply power required by the chip set 30 in opening the electromagnetic valve 10 and in stand-by mode. In addition, the chip set 30 is provided with a capacitor (not shown) for storage of a certain amount of electric charge.

The power supply unit 50 is a small type hydraulic power unit and provided at a proper position of the fluid channel 40 passed by the fluid. The power supply unit 50 can generate a basic voltage (V) and current (A) by means of the velocity of the flowing fluid in a unit time. The voltage (V) and current (A) is transmitted to the chip set 30 by means of two leads 51, 52, thereby creating a basic work (W) for the chip set 30 to open the electromagnetic valve 10.

As described above, the amount of the work created by the power supply unit 50 depends on the velocity of flow and the passing time of the fluid. Based on the average rate of flow, supposed that the fluid passes through a 1/2 inch tube for 10˜ 12 seconds, the produced work by the power supply unit 50 amounts to 5 V×0.2 A=1 W. The power required for opening the electromagnetic valve 10 is 0.01 W/sec. Therefore, 1 W is enough for 50 times (100/2=50) to open and close the electromagnetic valve 10. Accordingly, the power supply unit 50 can provide at least 0.5˜1 W of power to the chip set 30 each time when the hydraulic system is used. After completion of actuation of the electromagnetic valve 10, the remaining power will be automatically stored to the capacitor.

Thus, the present invention is characterized in that the power to open the electromagnetic valve 10 is created by the hydroelectric generation, and that the remaining power can be stored by the capacitor of the chip set 30 to supply the power required by the chip set 30 in stand-by mode.

The maximal voltage stored in the capacitor is preset between 5 V and 12 V. The voltage of the capacitor is in full state before installation of the present invention. Besides, the required power by the chip set 30 in stand-by mode is 0.0006 W/hr. In other words, the capacitor can provide the power required by the chip set 30 in stand-by mode for at least 300 days. Between times, if fluid flows through the power supply unit 50 to create a basic work, the created power can be added to the capacitor.

Furthermore, in order to meet requirements in different places, the capacitor of the chip set 30 used to store the power can be replaced by charging battery or the like.

Also, the power required by the hydraulic system is provided by the power supply unit 50 in a way of hydroelectric generation so that the inconvenience of using batteries is eliminated. In order to meet the moisture-resistant or hidden requirements, the chip set 30, the power supply unit 50 and the electromagnetic valve 10 can be integrated in a body or arranged inside the wall.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A power supply unit for a hydraulic system, wherein an electromagnetic valve is arranged near a spout of a flow channel and controlled by a chip set in an opening or closing state, and said chip set is connected to a sensor exposed to the outside, and wherein said sensor transmits a sensed signal to said chip set for automatic opening or closing said electromagnetic valve to supply water when objects approach to said spout,
characterized in that the power supply unit is provided at a proper position of said fluid channel passed by the fluid, and that said power supply unit generates a basic voltage (V) and current (A) by means of the velocity of the flowing fluid in a unit time, and that said voltage (V) and current (A) is transmitted to said chip set by means of two leads, thereby creating a basic work (W) for said chip set to open or to close the electromagnetic valve.

2. A power supply unit for a hydraulic system as claimed in claim 1, wherein said chip set includes a capacitor or a charging battery for storage of the power created by said power supply unit.
